(19) United States
(12) Patent Application Publication
(10) Pub. No.: US 2025/0118199 A1
(43) Pub. Date: Apr. 10, 2025

(54) IMPROVEMENT ASSISTANCE APPARATUS, SYSTEM, METHOD, AND COMPUTER READABLE MEDIUM

(71) Applicant: NEC Corporation, Minato- ku,Tokyo (JP)

(72) Inventors: Shuei YAMADA, Tokyo (JP); Shintaro CHIKU, Tokyo (JP); Naoko FUKUSHI, Tokyo (JP); Masanori KUKI, Tokyo (JP); Shuhei MIZUGUCHI, Tokyo (JP); Kosei KOBAYASHI, Tokyo (JP)

(73) Assignee: NEC Corporation, Minato- ku, Tokyo (JP)

(21) Appl. No.: 18/833,964

(22) PCT Filed: Feb. 1, 2022
(86) PCT No.: PCT/JP2022/003849

§ 371 Date: Jul. 29, 2024

(51) Int. Cl. G08G 1/01; G06V 20/54; G06V 20/58; G08G 1/16

(52) U.S. Cl. CPC G08G 1/0133; G06V 20/54; G06V 20/58; G08G 1/0108; G08G 1/0145; G08G 1/166; G06V 2201/08

(57) ABSTRACT

A camera captures a road. A traffic status acquisition means of an improvement assistance apparatus acquires a camera image from the camera. The traffic status acquisition means acquires a traffic status of a bicycle from the camera image acquired from the camera. A determining means determines an improvement priority of a bicycle lane, based on the traffic status of the bicycle acquired by the traffic status acquisition means and an improvement status of a bicycle lane on the road.

### TECHNICAL FIELD

The present disclosure relates to an improvement assistance apparatus, a system, a method, and a computer-readable medium.

### BACKGROUND ART

As a related art, Patent Literature 1 discloses a traffic state investigation system. The traffic state investigation system described in Patent Literature 1 uses a security camera for traffic volume investigation. The traffic state investigation system acquires moving image data from a plurality of cameras installed in various places, and performs moving image identification processing on the acquired moving image data. The traffic state investigation system identifies a person, a bicycle, a motorcycle, and an automobile in the moving image identification processing, determines a direction in which the person, the bicycle, the motorcycle, and the automobile move, and thereby counts a traffic volume for each direction.

The traffic state investigation system displays an investigation result of the traffic volume on a display. For example, when a user selects a button indicating the traffic volume of a person, the traffic state investigation system displays a degree of congestion of the person by color-coding on a map of the whole city and town. Further, when a user selects a button indicating the traffic volume of a bicycle, the traffic state investigation system displays a degree of congestion of the bicycle by color-coding on the map of the whole city and town.

### CITATION LIST

### Patent Literature

Patent Literature 1: Japanese Unexamined Patent Application Publication No. 2005-215909

### SUMMARY OF INVENTION

### Technical Problem

Patent Literature 1 describes that an investigation result of a traffic volume can be used as data guiding a guideline for city planning in a local government. Specifically, Patent Literature 1 discloses that necessity of providing a sidewalk on a road can be studied by comparing the traffic volume of a person and the traffic volume of a vehicle with each other. However, Patent Literature 1 does not disclose that the investigation result of the traffic volume is used for improvement (development) of a bicycle lane.

In view of the above circumstances, an object of the present disclosure is to provide an improvement assistance apparatus, a system, a method, and a computer-readable medium that are capable of providing information useful for improvement of a bicycle lane to a user.

### Solution to Problem

In order to achieve the above object, the present disclosure provides an improvement assistance apparatus as a first aspect. The improvement assistance apparatus includes: a traffic status acquisition means for acquiring a camera image from a camera capturing a road, and acquiring a traffic status of a bicycle from the acquired camera image; and a determining means for determining an improvement priority of a bicycle lane, based on the acquired traffic status of the bicycle and an improvement status of a bicycle lane on the road.

The present disclosure provides an improvement assistance system as a second aspect. The improvement assistance system includes: one or more cameras each configured to capture a road; and an improvement assistance apparatus configured to be used for improvement assistance of a bicycle lane. The improvement assistance apparatus includes a traffic status acquisition means for acquiring a camera image from the one or more cameras and acquiring a traffic status of a bicycle from the acquired camera image, and a determining means for determining an improvement priority of a bicycle lane, based on the acquired traffic status of the bicycle and an improvement status of a bicycle lane on the road.

The present disclosure provides an improvement assistance method as a third aspect. The improvement assistance method includes: acquiring a camera image from a camera capturing a road, and acquiring a traffic status of a bicycle from the acquired camera image; and determining an improvement priority of a bicycle lane, based on the acquired traffic status of the bicycle and an improvement status of a bicycle lane on the road.

The present disclosure provides a computer-readable medium as a fourth aspect. The computer-readable medium stores a program for causing a computer to execute processing including: acquiring a camera image from a camera capturing a road, and acquiring a traffic status of a bicycle from the acquired camera image; and determining an improvement priority of a bicycle lane, based on the acquired traffic status of the bicycle and an improvement status of a bicycle lane on the road.

### Advantageous Effects of Invention

An improvement assistance apparatus, a system, a method, and a computer-readable medium according to the present disclosure can provide information useful for improvement of a bicycle lane to a user.

### BRIEF DESCRIPTION OF DRAWINGS

FIG. 1 is a block diagram illustrating a schematic configuration of an improvement assistance system according to the present disclosure;

FIG. 2 is a block diagram illustrating an improvement assistance system according to one example embodiment of the present disclosure;

FIG. 3 is a block diagram illustrating a configuration example of an improvement assistance apparatus;

FIG. 4 is a schematic diagram schematically illustrating an improvement status of a bicycle lane;

FIG. 5 is a flowchart illustrating an operation procedure in the improvement assistance apparatus; and

FIG. 6 is a block diagram illustrating a configuration example of a computer apparatus.

### EXAMPLE EMBODIMENT

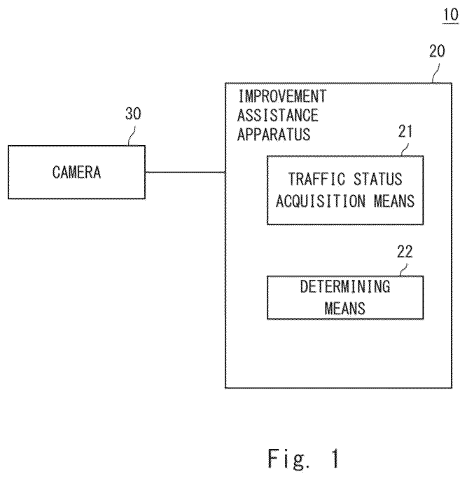

Prior to the description of an example embodiment of the present disclosure, an outline of the present disclosure will be described. FIG. 1 illustrates a schematic configuration of an improvement assistance system according to the present disclosure. An improvement assistance system 10 includes an improvement assistance apparatus 20 and one or more cameras 30. Each of the one or more cameras 30 captures a road. The improvement assistance apparatus 20 is an apparatus used for improvement assistance of a bicycle lane on a road.

The improvement assistance apparatus 20 includes a traffic status acquisition means 21, and a determining means 22. The traffic status acquisition means 21 acquires a camera image from the camera 30, and acquires a traffic status of a bicycle on a road from the acquired camera image. The determining means 22 determines an improvement priority of a bicycle lane, based on the acquired traffic status of the bicycle and an improvement status of the bicycle lane on the road.

In the present disclosure, the traffic status acquisition means 21 acquires a traffic status of a bicycle from a camera video. The determining means 22 determines an improvement priority of a bicycle lane by using the acquired traffic status. In the present disclosure, the determining means 22 determines a road having a higher priority of bicycle lane improvement by, for example, collating the acquired traffic status of the bicycle and a current improvement status of the bicycle lane with each other. By referring to a result of the determination, a user such as a road administrator can know where to preferentially improve the bicycle lane. As described above, according to the present disclosure, it is possible to provide information useful for improvement of a bicycle lane to a user.

Hereinafter, the example embodiment of the present disclosure will be described in detail with reference to the drawings. Note that, the following description and drawings are omitted and simplified as appropriate for clarity of description. Further, in each of the following drawings, the same elements and similar elements are denoted by the same reference signs, and redundant descriptions are omitted as necessary.

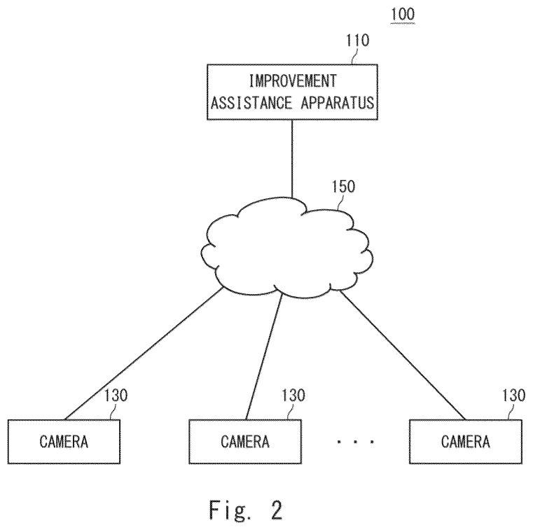

FIG. 2 illustrates an improvement assistance system according to one example embodiment of the present disclosure. An improvement assistance system 100 includes an improvement assistance apparatus 110, and one or more cameras 130. The improvement assistance apparatus 110 is connected to the one or more cameras 130 via a network 150. The network 150 includes, for example, a network using a communication line standard such as long term evolution (LTE). The network 150 may include a wireless communication network such as WiFi (registered trademark) or a fifth generation mobile communication system. The improvement assistance system 100 corresponds to the improvement assistance system 10 illustrated in FIG. 1.

Each camera 130 captures a road. The camera 130 is installed in a road facility such as a traffic light installed on a road, for example. The camera 130 may be installed in a road side unit (RSU). Alternatively, the camera 130 may be mounted on a moving body traveling on a road. The moving body may include, for example, at least one of an automobile, a bus, a truck, and a tram. The moving body may be configured to be capable of automatic driving (autonomous driving), based on information of a sensor mounted on the moving body. The camera 130 corresponds to the camera 30 illustrated in FIG. 1.

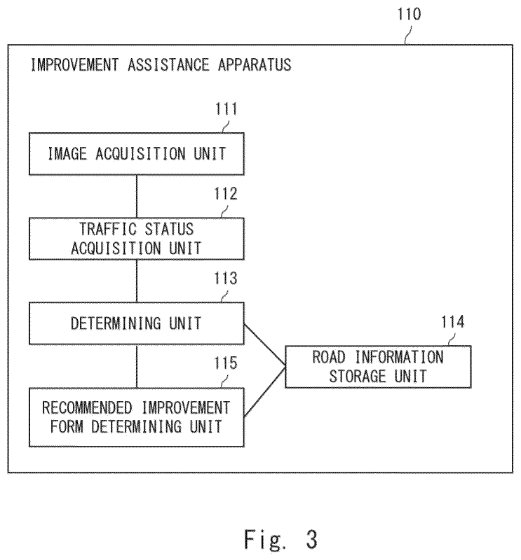

The improvement assistance apparatus 110 is an apparatus used for improvement assistance of a bicycle lane. FIG. 3 illustrates a configuration example of the improvement assistance apparatus 110. The improvement assistance apparatus 110 includes an image acquisition unit 111, a traffic status acquisition unit 112, a determining unit 113, a road information storage unit 114, and a recommended improvement form determining unit 115. The improvement assistance apparatus 110 may be configured by using, for example, a computer having a processor and a memory. At least a part of functions of each unit in the improvement assistance apparatus 110 may be achieved by the processor operating according to a program read from the memory. The improvement assistance apparatus 110 corresponds to the improvement assistance apparatus 20 illustrated in FIG. 1.

The image acquisition unit 111 acquires a camera image from the camera 130 (refer to FIG. 2). The traffic status acquisition unit 112 acquires a traffic status of a bicycle on a road from the acquired camera image. For example, the image acquisition unit 111 acquires a camera image from each of a plurality of the cameras 130 installed at a plurality of points. The traffic status acquisition unit 112 acquires the traffic status of the bicycle at each of the plurality of points where the camera 130 is installed. The traffic status acquisition unit 112 may acquire the traffic status of the bicycle by, for example, applying the camera image to an artificial intelligence (AI) model. The traffic status acquisition unit 112 corresponds to the traffic status acquisition means 21 illustrated in FIG. 1.

The traffic status acquisition unit 112 acquires, for example, a traffic volume of the bicycle on the road, behavior of the bicycle, or both thereof as the traffic status of the bicycle. The traffic status acquisition unit 112 may acquire the behavior of the bicycle that leads to an accident as the traffic status of the bicycle. The behavior of the bicycle that leads to an accident may include at least one of traffic violations such as, for example, wandering, sticking out to a roadway, approaching to a pedestrian, and ignoring a signal. The traffic status acquisition unit 112 may acquire the traffic status of a vehicle and a pedestrian on the road in addition to the traffic status of the bicycle. The traffic status acquisition unit 112 may acquire, for example, a status in which a bicycle and an automobile have come into contact with each other or come near into contact with each other as the traffic status of the bicycle. Further, the traffic status acquisition unit 112 may acquire, for example, a status in which a bicycle and a pedestrian come into contact with each other or come near into contact with each other as the traffic status of the bicycle.

The traffic status acquisition unit 112 may acquire or estimate a usage form of a bicycle from a camera image. The usage form of a bicycle may include, for example, commuting, going to school, and shopping. The traffic status acquisition unit 112 identifies a position of a facility such as a station or a school with reference to, for example, map information. The traffic status acquisition unit 112 estimates that the usage form is commuting or going to school, for example, in a case where there are many bicycles traveling to a facility such as a nearby station or school during a time period of commuting and going to school. Alternatively, the traffic status acquisition unit 112 estimates that the usage form is commuting or shopping in a case where there are many bicycles traveling to a nearby supermarket in a specific time period such as evening.

The road information storage unit 114 stores information related to an improvement status of a bicycle lane on a road. The improvement status of the bicycle lane includes a status in which the bicycle lane is improved as a bicycle-dedicated lane, a status in which an automobile and a bicycle are separated from each other, and a status in which a roadway and a bicycle lane are mixed. The road information storage unit 114 may store attribute information of a road. The attribute information includes information indicating a type of a road such as a trunk road, a community road, and a school route. For example, a user such as a road administrator may investigate the improvement status of a bicycle lane on a road, and store an investigation result in a database in the road information storage unit 114. The information stored in the road information storage unit 114 may be updated at timing when improvement of the bicycle lane is performed.

The determining unit 113 determines an improvement priority of a bicycle lane, based on the acquired traffic status of the bicycle and an improvement status of the bicycle lane on a road. For example, the determining unit 113 acquires a current improvement status of the bicycle lane on the road from the road information storage unit 114. The determining unit 113 determines the improvement priority of the bicycle lane according to the traffic status of the bicycle and the current improvement status of the bicycle lane on the road.

When the usage form of the bicycle has been acquired by the traffic status acquisition unit 112, the determining unit 113 may determine the improvement priority, based on the acquired usage form of the bicycle. Alternatively or additionally, the determining unit 113 may determine the improvement priority, based on attribute information of a road such as, for example, a trunk road, a community road, and a school route. When a traffic status of an automobile and a pedestrian has been acquired, the determining unit 113 may determine the improvement priority of the bicycle lane, based on the traffic status of the automobile and the pedestrian. The determining unit 113 corresponds to the determining means 22 illustrated in FIG. 1.

The recommended improvement form determining unit (recommended improvement form determining means) 115 determines a recommended improvement form of a bicycle lane, based on a traffic status of a bicycle and an improvement form of the bicycle lane on a road. The recommended improvement form determining unit 115 determines the recommended improvement form according to the traffic status of the bicycle and the current improvement form of the bicycle lane from among a plurality of improvement forms of the bicycle lane. The recommended improvement form determining unit 115 determines, for example, the recommended improvement form of a bicycle lane between a plurality of intersections. The recommended improvement form determining unit 115 recommends the recommended improvement form of the bicycle lane to a user such as a road administrator.

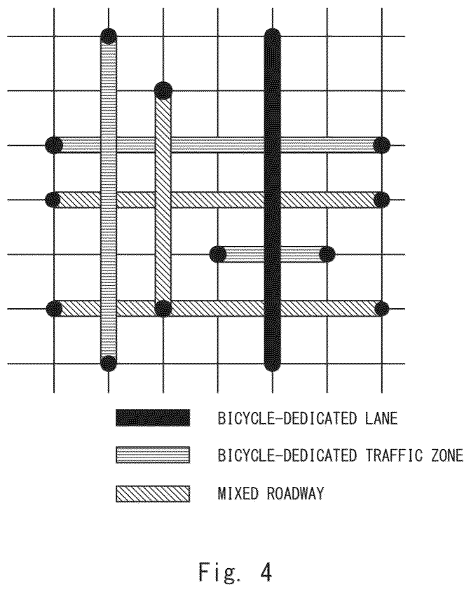

FIG. 4 is a diagram schematically illustrating an improvement status of a bicycle lane. A grid-shaped line in FIG. 4 represents a road, and FIG. 4 illustrates in which section on the road a bicycle lane is being improved. The road includes a section being improved as a bicycle-dedicated lane, a section being provided with a bicycle-dedicated traffic zone, and a section (mixed roadway) in which a bicycle and an automobile are mixed. The section being improved as a bicycle-dedicated lane indicates, for example, a section in which an automobile and a bicycle are structurally separated from each other. Specifically, in the bicycle-dedicated lane, a portion on which an automobile travels and a portion on which a bicycle travels are separated by using a curb or the like. The section being provided with the bicycle-dedicated traffic zone indicates a section in which an automobile and a bicycle are visually separated from each other by color-coding a pavement or the like.

The determining unit 113 determines the improvement priority according to a traffic status of a bicycle for each point and an improvement status of a bicycle lane. For example, the determining unit 113 determines whether a bicycle-dedicated lane is already improved at each point. The determining unit 113 determines whether a bicycle-dedicated lane or a bicycle-dedicated traffic zone should be improved at a point where the bicycle-dedicated lane is not improved, based on, for example, a traffic volume of an automobile and a bicycle, and dangerous behavior of the bicycle. When determining that the bicycle-dedicated lane or the bicycle-dedicated traffic zone should be improved, the determining unit 113 determines the improvement priority according to a degree of dangerous behavior of the bicycle. The improvement priority may be represented by, for example, two values of “high” and “low”, or a plurality of levels of the improvement priority may be represented by numerical values. The determining unit 113 may determine the improvement priority according to whether a road is a school route or a trunk road. Alternatively, the determining unit 113 may determine the improvement priority in consideration of the traffic volume of the automobile. The improvement priority may be a relative evaluation within a specific area. For example, the improvement priority may indicate a priority within a plurality of roads to be managed by a road administrator.

The recommended improvement form determining unit 115 determines a recommended improvement form of a bicycle lane, based on a traffic status and a current improvement status of the bicycle lane. The recommended improvement form determining unit 115 determines an improvement form recommending improvement of a bicycle-dedicated lane or improvement of a bicycle traffic zone in a case where traffic of an automobile and traffic of a bicycle are not separated from each other, for example, at a point where a traffic volume of the bicycle is large or dangerous behavior is observed. The recommended improvement form determining unit 115 may determine the recommended improvement form for a point where the improvement priority is higher than a certain level.

When the usage form of a bicycle has been acquired, the recommended improvement form determining unit 115 may determine the recommended improvement form in consideration of the usage form. The recommended improvement form determining unit 115 may determine the recommended improvement form of the bicycle lane on a road on a route by calculating the route to a school or a station, for example, when use in going to school is large.

The recommended improvement form determining unit 115 may determine not only the recommended improvement form of the bicycle lane but also a countermeasure plan around an intersection. For example, it is assumed that the traffic status acquisition unit 112 acquires a traffic status indicating dangerous traveling of a bicycle in the intersection. In this case, the recommended improvement form determining unit 115 may determine a countermeasure plan that recommends providing a road surface marking indicating that a two-stage right turn is necessary in a vicinity of the intersection. Alternatively, the recommended improvement form determining unit 115 may determine a countermeasure plan that recommends providing a road surface marking indicating a traffic place and a traffic direction of a bicycle when a traffic status indicating abnormal approach between the automobile and the bicycle has been acquired. The recommended improvement form determining unit 115 may determine a countermeasure plan in which a stop position of a bicycle is set forward a stop position of an automobile when occurrence of a left-turn collision accident is anticipated at the intersection.

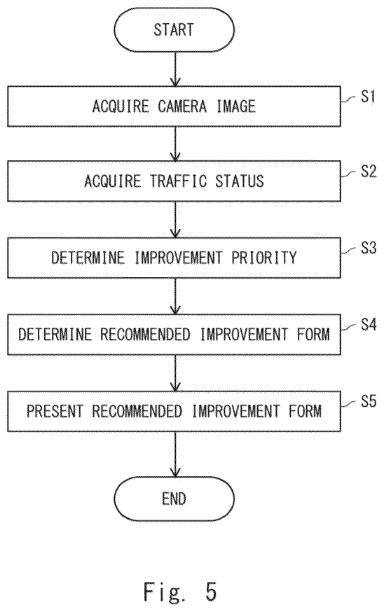

Subsequently, an operation procedure will be described. FIG. 5 illustrates an operation procedure (improvement assistance method) in the improvement assistance apparatus 110. The camera 130 captures a road at a place such as an intersection. The image acquisition unit 111 acquires a camera image from the camera 130 (step S1). The traffic status acquisition unit 112 acquires a traffic status of a bicycle on a road from the acquired camera image (step S2). In step S2, the traffic status acquisition unit 112 acquires, for example, a traffic volume of the bicycle on the road and behavior of the bicycle.

The determining unit 113 determines an improvement priority of a bicycle lane, based on the traffic status of the bicycle acquired in step S2 and an improvement status of the bicycle lane stored in the road information storage unit 114 (step S3). In step S3, the determining unit 113 determines the improvement priority of the bicycle lane according to, for example, the traffic status of the bicycle in a section between a plurality of intersections and the current improvement status of the bicycle lane in the section. By the determining unit 113 determining the improvement priority for each section (point), a place where improvement is preferentially necessary is specified.

The recommended improvement form determining unit 115 determines a recommended improvement form of the bicycle lane, based on the traffic status of the bicycle and the improvement form of the bicycle lane on the road (step S4). In step S4, the recommended improvement form determining unit 115 may determine the recommended improvement form of the bicycle lane for a section in which the improvement priority is determined to be high. The recommended improvement form determining unit 115 displays the recommended improvement form of the bicycle lane on a display screen of a display, and presents the recommended improvement form to a user such as a road administrator (step S5). In step S5, the recommended improvement form determining unit 115 displays, for example, a section having a high improvement priority and the recommended improvement form on a map, and presents the recommended improvement form to a user.

In the present example embodiment, the traffic status acquisition unit 112 analyzes a camera image of the camera 130, and acquires a traffic status of a bicycle. The determining unit 113 determines an improvement priority of a bicycle lane, based on the traffic status of the bicycle and an improvement status of the bicycle lane. The recommended improvement form determining unit 115 determines an improvement form of the bicycle lane, based on the traffic status of the bicycle and the improvement status of the bicycle lane. In the present example embodiment, a user can know where to preferentially improve the bicycle lane by referring to the determined improvement priority of the bicycle lane. By doing so, it becomes easy to improve the bicycle lane within a limited time and a limited budget. Further, a user can know in what kind of improvement form the bicycle lane should be improved by referring to the recommended improvement form of the bicycle lane. Furthermore, when a countermeasure plan is determined by the recommended improvement form determining unit 115, a user can know the countermeasure plan by which the bicycle can safely travel at a place such as an intersection.

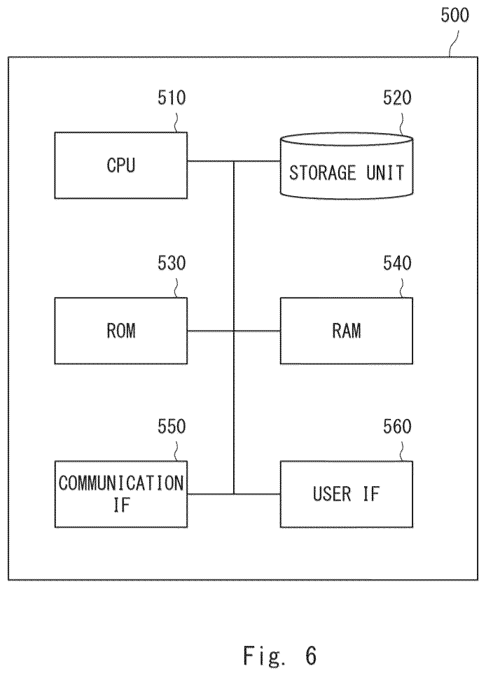

In the present disclosure, the improvement assistance apparatus 110 may be configured as a computer apparatus (server apparatus). FIG. 6 illustrates a configuration example of the computer apparatus that may be used as the improvement assistance apparatus 110. A computer apparatus 500 includes a control unit (central processing unit (CPU)) 510, a storage unit 520, a read only memory (ROM) 530, a random access memory (RAM) 540, a communication interface (IF) 550, and a user interface 560.

The communication interface 550 is an interface for connecting the computer apparatus 500 and a communication network to each other via a wired communication means, a wireless communication means, or the like. The user interface 560 includes a display unit such as, for example, a display. Further, the user interface 560 includes an input unit such as a keyboard, a mouse, and a touch panel.

The storage unit 520 is an auxiliary storage apparatus capable of holding various types of data. The storage unit 520 is not necessarily a part of the computer apparatus 500, and may be an external storage apparatus, or a cloud storage connected to the computer apparatus 500 via a network.

The ROM 530 is a non-volatile storage apparatus. For example, a semiconductor storage apparatus such as a flash memory having a relatively small capacity is used for the ROM 530. A program executed by the CPU 510 may be stored in the storage unit 520 or the ROM 530. The storage unit 520 or the ROM 530 stores various programs for achieving the functions of each unit in the improvement assistance apparatus 110, for example.

The above-described program can be stored using various types of non-transitory computer-readable media, and supplied to the computer apparatus 500. The non-transitory computer-readable medium includes various types of tangible storage media. Examples of the non-transitory computer-readable medium includes a magnetic recording medium such as, for example, a flexible disk, a magnetic tape, or a hard disk, a magneto-optical recording medium such as, for example, a magneto-optical disk, an optical disk medium such as a compact disc (CD), or a digital versatile disk (DVD), and a semi-conductor memory such as a mask ROM, a programmable ROM (PROM), an erasable PROM (EPROM), a flash ROM, or a RAM. Further, the program may also be supplied to a computer using various types of transitory computer-readable media. Examples of the transitory computer-readable medium include an electric signal, an optical signal, and an electromagnetic wave. The transitory computer-readable medium can supply the program to the computer via a wired communication path such as an electric wire and an optical fiber, or a wireless communication path.

The RAM 540 is a volatile storage apparatus. Various types of semiconductor memory devices such as a dynamic random access memory (DRAM) or a static random access memory (SRAM) are used for the RAM 540.

The RAM 540 may be used as an internal buffer temporarily storing data and the like. The CPU 510 loads a program stored in the storage unit 520 or the ROM 530 into the RAM 540, and executes the program. By the CPU 510 executing the program, the functions of each unit in the improvement assistance apparatus 110 can be achieved. The CPU 510 may include an internal buffer capable of temporarily storing data and the like.

Note that, information stored in the road information storage unit 114 is not necessarily input by a person. For example, the computer may determine an improvement status of a bicycle lane, based on a camera image, and store a determined result in the road information storage unit 114. For example, the computer may acquire a camera image acquired by capturing a road, determine whether a portion on which a bicycle travels and a portion on which an automobile travels are separated by a curb or the like, and determine the improvement status of the bicycle lane. Alternatively, the computer may analyze what kind of pavement is being placed on a road surface, based on a camera image, and determine the improvement status of the bicycle lane. When a camera image includes a road sign indicating the improvement status of the bicycle lane, the computer may determine the improvement status of the bicycle lane, based on information of the road sign.

While the example embodiment of the present disclosure has been described in detail above, the present disclosure is not limited to the above-described example embodiment, and changes and modifications to the above-described example embodiment without departing from the spirit of the present disclosure are also included in the present disclosure.

For example, some or all of the above-described example embodiment may be described the supplementary notes as follows, but are not limited thereto.

### Supplementary Note 1

An improvement assistance apparatus including:
a traffic status acquisition means for acquiring a camera image from a camera capturing a road, and acquiring a traffic status of a bicycle from the acquired camera image; and
a determining means for determining an improvement priority of a bicycle lane, based on the acquired traffic status of the bicycle and an improvement status of a bicycle lane on the road.

### Supplementary Note 2

The improvement assistance apparatus according to supplementary note 1, wherein the traffic status acquisition means acquires at least one of a traffic volume and behavior of a bicycle on the road as a traffic status of the bicycle.

### Supplementary Note 3

The improvement assistance apparatus according to supplementary note 1 or 2, wherein the traffic status acquisition means acquires behavior of a bicycle that leads to an accident as a traffic status of the bicycle.

### Supplementary Note 4

The improvement assistance apparatus according to any one of supplementary notes 1 to 3, wherein
the traffic status acquisition means further acquires a traffic status of an automobile and a pedestrian on the road, and
the determining means further determines the improvement priority, based on a traffic status of the automobile and the pedestrian.

### Supplementary Note 5

The improvement assistance apparatus according to any one of supplementary notes 1 to 4, further including a recommended improvement form determining means for determining a recommended improvement form of a bicycle lane, based on a traffic status of the bicycle and an improvement form of a bicycle lane on the road.

### Supplementary Note 6

The improvement assistance apparatus according to supplementary note 5,wherein the recommended improvement form determining means determines a recommended improvement form according to a traffic status of the bicycle and an improvement form of a bicycle lane on the road, from among a plurality of improvement forms including a form in which a bicycle lane is improved as a bicycle-dedicated lane, a form in which a bicycle lane and a roadway are separated from each other, and a form in which a roadway and a bicycle lane are mixed.

### Supplementary Note 7

The improvement assistance apparatus according to any one of supplementary notes 1 to 6, wherein
the traffic status acquisition means acquires a usage form of the bicycle from the camera image as a traffic status of the bicycle, and
the determining means determines the improvement priority, based on the acquired usage form of the bicycle.

### Supplementary Note 8

The improvement assistance apparatus according to any one of supplementary notes 1 to 7, wherein the determining means further determines the improvement priority, based on attribute information of the road.

### Supplementary Note 9

The improvement assistance apparatus according to any one of supplementary notes 1 to 8, wherein the traffic status acquisition means acquires the camera image from each of a plurality of cameras installed at a plurality of points, and acquires a traffic status of the bicycle at each of the plurality of points.

### Supplementary Note 10

The improvement assistance apparatus according to any one of supplementary notes 1 to 9, wherein the traffic status acquisition means acquires the camera image from at least one of a moving body traveling on the road, and a road facility installed on the road.

### Supplementary Note 11

The improvement assistance system including:
one or more cameras each configured to capture a road; and
an improvement assistance apparatus configured to be used for improvement assistance of a bicycle lane,
wherein the improvement assistance apparatus includes
a traffic status acquisition means for acquiring a camera image from the one or more cameras, and acquiring a traffic status of a bicycle from the acquired camera image, and
a determining means for determining an improvement priority of a bicycle lane, based on the acquired traffic status of the bicycle and an improvement status of a bicycle lane on the road.

### Supplementary Note 12

The improvement assistance system according to supplementary note 11,wherein the traffic status acquisition means acquires at least one of a traffic volume and behavior of a bicycle on the road as a traffic status of the bicycle.

### Supplementary Note 13

The improvement assistance system according to supplementary note 11 or 12, wherein the one or more cameras include at least one of a camera installed in a moving body traveling on the road, and a camera installed in a road facility installed on the road.

### Supplementary Note 14

An improvement assistance method including:
acquiring a camera image from a camera capturing a road, and acquiring a traffic status of a bicycle from the acquired camera image; and
determining an improvement priority of a bicycle lane, based on the acquired traffic status of the bicycle and an improvement status of a bicycle lane on the road.

### Supplementary Note 15

A non-transitory computer-readable medium storing a program for causing a computer to execute processing including:
acquiring a camera image from a camera capturing a road, and acquiring a traffic status of a bicycle from the acquired camera image; and
determining an improvement priority of a bicycle lane, based on the acquired traffic status of the bicycle and an improvement status of a bicycle lane on the road.

### REFERENCE SIGNS LIST

10 IMPROVEMENT ASSISTANCE SYSTEM
20 IMPROVEMENT ASSISTANCE APPARATUS
21 TRAFFIC STATUS ACQUISITION MEANS
22 DETERMINING MEANS
30 CAMERA
100 IMPROVEMENT ASSISTANCE SYSTEM
110 IMPROVEMENT ASSISTANCE APPARATUS
111 IMAGE ACQUISITION UNIT
112 TRAFFIC STATUS ACQUISITION UNIT
113 DETERMINING UNIT
114 ROAD INFORMATION STORAGE UNIT
115 RECOMMENDED IMPROVEMENT FORM DETERMINING UNIT
130 CAMERA
150 NETWORK
500 COMPUTER APPARATUS
510 CONTROL UNIT
520 STORAGE UNIT
530 ROM
540 RAM
550 COMMUNICATION INTERFACE
560 USER INTERFACE

What is claimed is:

1. An improvement assistance apparatus comprising:
a memory storing instructions; and
a processor configured to execute the instructions to:
acquire a camera image from a camera capturing a road, and acquire traffic status of a bicycle from the acquired camera image; and
determine an improvement priority of a bicycle lane, based on the acquired traffic status of the bicycle and an improvement status of a bicycle lane on the road.

2. The improvement assistance apparatus according to claim 1, wherein the processor is configured to execute the instructions to acquire at least one of a traffic volume and behavior of a bicycle on the road as a traffic status of the bicycle.

3. The improvement assistance apparatus according to claim 1, wherein the processor is configured to execute the instructions to acquire behavior of a bicycle that leads to an accident as a traffic status of the bicycle.

4. The improvement assistance apparatus according to claim 1, wherein the processor is configured to execute the instructions to:
acquire a traffic status of an automobile and a pedestrian on the road, and
determine the improvement priority, based on a traffic status of the automobile and the pedestrian.

5. The improvement assistance apparatus according to claim 1, wherein the processor is configured to execute the instructions to determine a recommended improvement form of a bicycle lane, based on a traffic status of the bicycle and an improvement form of a bicycle lane on the road.

6. The improvement assistance apparatus according to claim 5, wherein the processor is configured to execute the instructions to determine a recommended improvement form according to a traffic status of the bicycle and an improvement form of a bicycle lane on the road, from among a plurality of improvement forms including a form in which a bicycle lane is improved as a bicycle-dedicated lane, a form in which a bicycle lane and a roadway are separated from each other, and a form in which a roadway and a bicycle lane are mixed.

7. The improvement assistance apparatus according to claim 1, wherein the processor is configured to execute the instructions to:
acquire the traffic status acquisition means acquires a usage form of the bicycle from the camera image as a traffic status of the bicycle, and
determine the determining means determines the improvement priority, based on the acquired usage form of the bicycle.

8. The improvement assistance apparatus according to claim 1, wherein the processor is configured to execute the instructions to determine the improvement priority, based on attribute information of the road.

9. The improvement assistance apparatus according to claim 1, wherein the processor is configured to execute the instructions to acquire the camera image from each of a plurality of cameras installed at a plurality of points, and acquire a traffic status of the bicycle at each of the plurality of points.

10. The improvement assistance apparatus according to claim 1, wherein the processor is configured to execute the instructions to acquire the camera image from at least one of a moving body traveling on the road, and a road facility installed on the road.

11. An improvement assistance system comprising:
one or more cameras each configured to capture a road; and
the improvement assistance apparatus according to claim 1.

12. The improvement assistance system according to claim 11, wherein the processor is configured to execute the instructions to acquire at least one of a traffic volume and behavior of a bicycle on the road as a traffic status of the bicycle.

13. The improvement assistance system according to claim 11, wherein the one or more cameras include at least one of a camera installed in a moving body traveling on the road, and a camera installed in a road facility installed on the road.

14. An improvement assistance method comprising:
acquiring a camera image from a camera capturing a road, and acquiring a traffic status of a bicycle from the acquired camera image; and
determining an improvement priority of a bicycle lane, based on the acquired traffic status of the bicycle and an improvement status of a bicycle lane on the road.

15. A non-transitory computer-readable medium storing a program for causing a computer to execute processing including:
acquiring a camera image from a camera capturing a road, and acquiring a traffic status of a bicycle from the acquired camera image; and
determining an improvement priority of a bicycle lane, based on the acquired traffic status of the bicycle and an improvement status of a bicycle lane on the road.
